(19) United States
(12) Patent Application Publication
(10) Pub. No.: US 2026/0044270 A1
(43) Pub. Date: Feb. 12, 2026

(54) Power Save Mode By Disabling Multi-Channel Memory

(71) Applicant: Google LLC, Mountain View, CA (US)

(72) Inventor: Aruna Kumar Tripathy, Hyderabad (IN)

(21) Appl. No.: 18/799,484

(22) Filed: Aug. 9, 2024

(51) Int. Cl. G06F 3/06

(52) U.S. Cl. CPC G06F 3/0625; G06F 3/0634; G06F 3/0673

(57) ABSTRACT

A power save mode in multi-channel memory device receives a request to turn off at least one memory channel. The request may be received from a user where a user preference is received as part of the request and includes an indication of the number of memory channels to turn off. The user preference can be stored in a configuration setting and the user preference can be retrieved from the stored configuration setting to enter power save mode. When entering the power save mode, the device is rebooted. Upon restart of the device in power save mode, the device calculates a memory address hash map for the active memory channels. The device may be a system on chip and may include a mobile device operated by battery. When operating in power save mode, the power demand of the disabled memory channels is eliminated to conserve power and battery life.

### BACKGROUND

Mobile compute devices, such as smart phones, tablets, personal digital assistants (PDAs), and the like allow users to receive computer-related services from any location. These devices contain many components that require electrical power to function. Mobile devices can use batteries to store electrical energy in a portable form and allow the device to operate when away from a fixed power source. As the device operates, the electrical energy stored in the battery is depleted, leading eventually to a complete discharge of the battery. Once discharged, the battery must be recharged, or the device will shut down due to lack of power.

Research and development efforts have been directed to power conservation and battery architecture to maximize battery life through power conservation or increased battery capacity. Increasing battery capacity may require increasing the size of the battery, which, in turn, typically increases the size of the device housing the battery. However, in product design, limiting size and weight are common goals.

### SUMMARY

Technology described in this disclosure provides methods and systems for implementing a power save mode in multi-channel memory device. In one or more processors, a request to enter a power save mode is received. In response to the request, at least one of the memory channels in the multi-channel memory device is turned off. The multi-channel DRAM module is configured in a power saving mode to use at least one remaining memory channel. The multi-channel DRAM module can be implemented in a system on chip. The request for entering the power save mode may be received from a user of the device. A user preference may be received as part of the request, the user preference including an indication of the number of memory channels to turn off, and the power save mode turns off memory channels based on the user preference. The user preference can be stored in a configuration setting of the multi-channel DRAM module, and the user preference can be retrieved from the stored configuration setting. In one example, the user preference can be stored in a universal flash storage partition on the multi-channel DRAM module. When entering the power save mode, the device is rebooted. An indication can be displayed to the user that the device will reboot upon entering power save mode. The indication can include an option for the user to cancel the power save mode request if the user does want the device to reboot at that time. During runtime, the device may lock out the initiation of power save mode to protect data being processed. Upon startup of power save mode, the device calculates a memory address hash map for the active memory channels.

A compute device includes a processor and a memory in communication with the processor. The memory can contain a number of memory channels. A power save mode is provided that reduces power consumption of the device by selectively turning off a number of the memory channels. A user interface can be configured to prompt a user to select the power save mode in the device. User preferences for entering the power save mode may be saved to the device, for example in a secured bootloader partition. The secure bootloader partition may include a universal flash storage partition. The device can be implemented in a system on chip architecture. When rebooting into the power save mode, the device can compute a memory address hash map corresponding to a number of active channels in the power save mode. The device provides protection against entering the power save mode or altering the power save mode during runtime. The selection of the power save mode may provide a user with a choice of the number of memory channels to turn off to conserve power.

### BRIEF DESCRIPTION OF THE DRAWINGS

FIG. 1 is a block diagram illustrating system on chip device that can implement the technology described in this disclosure.

FIG. 2 is a block diagram of a multi-channel memory system according to aspects of the described technology.

FIG. 3 is a block diagram of the multi-channel memory system of FIG. 2 in a power save mode according to aspects of the described technology.

FIG. 4 is a process flow diagram showing the operating and selection of a power save mode in a multi-channel device according to aspects of the described technology.

FIG. 5 is a process flow diagram for initiating a power save mode in a multi-channel device according to aspects of the described technology.

FIG. 6 is a block diagram of a compute device capable of performing a power save mode according to aspects of the described technology.

### DETAILED DESCRIPTION

Multi-channel memory systems, such as systems used in mobile devices based on system on chip (SoC) generally use all available memory channels and associated dynamic random-access memory (DRAM) to maximize performance. Multi-channel DRAMs improve performance, but demand increased power consumption. A memory channel receives power for the DRAM as well as the memory channel microcontroller. When multiple memory channels are implemented, this power usage is multiplied by the number of active memory channels. The technology described herein provides improvements that can save power in multi-channel DRAM devices. The disclosed technology provides for a power save mode (PSM) implemented in device software (SW) in cooperation with the device bootloader (DBL). In PSM, the software provides an option to disable memory channels. As a result, the device can operate using only one or two memory channels, for example, while completely turning off power to the remaining memory channels to conserve power. A user configuration for initializing the device can contain user preferences indicating the device should operate in PSM.

During normal runtime operations, the active memory channels share memory addressing across the device. For this reason, memory channels cannot be powered off during runtime because current data storage may be lost, negatively impacting the device’s ability to process the data. Accordingly, a user can reboot the device while entering PSM using software configurations within the device. Device hardware is configured to support full or partial memory channels during device bootup. Power gates in the SoC are configured to isolate memory channels and turn off power to selected memory channels to save the power associated with operating those memory channels.

According to one example, a device can include four memory channels. Each memory channel has an associated memory controller (MC), a physical layer (PHY) between the DRAM hardware and the device, and the DRAM memory hardware. Software can interact with a user through a user interface. For example, the device may provide a settings menu that allows a user to indicate user preferences for various device features. In the case of power save mode, the user’s preferences may be captured and stored in a secured universal flash storage (UFS) partition in the device. The DBL can securely read the user preferences and use the preferences to enable the requested number of memory channels during bootup. Once the desired memory channels are initialized, the device software program the memory address hash map for only the required channels, and the remaining memory channels can be turned off to save power.

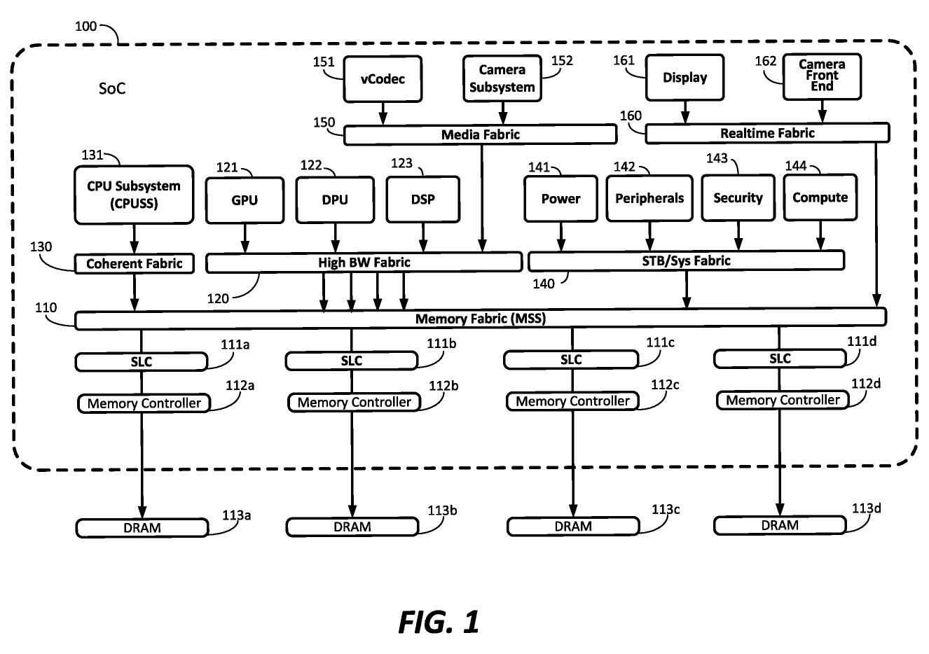

FIG. 1 is a block diagram of an SoC 100. The SoC 100 includes components of a compute device formed on the same piece of semiconductor material (i.e., chip). The SoC uses a number of interconnecting fabrics including a memory fabric 110, a high bandwidth fabric 120, a coherent fabric 130 a system fabric 140, a media fabric 150 and a real-time fabric 160. The fabrics 110, 120, 130, 140, 150, 160 allow components of the SoC 100 to interact with one another. For example, central processing unit (CPU) 131 is connected to system memory via coherent fabric 130 and memory fabric 110.

The compute device containing SoC 100 may be connected to a camera system that implements a real time feature through real-time fabric 160. The camera front end 162 may include a user interface that controls the functions of the camera. The camera may provide the view captured by the camera in real-time to a display 161. Additionally, the real-time fabric is in communication with memory via memory fabric 110. Other functions of the camera, which process the signals captured by the sensor in the camera may be included in camera subsystem 152 in cooperation with software for decoding and encoding the signals in video Codec 151. These produce media signals, which are communicated via media fabric 150. Media may interact with system memory via high bandwidth fabric 120.

High bandwidth fabric 120 provides high speed data communication with memory providing high speed access to components like the graphics processing unit (GPU) 121, the data processing unit (DPU) 122 and the digital signal processing module (DSP) 123. The system fabric 140 connects other system components to memory, including power source 141, identified as “Power” in FIG. 1, for supporting memory functions, support for peripherals 142, security for access to memory 143 and computing processing to data stored in memory 144.

The memory subsystem includes memory fabric 110 and memory components including system level cache (SLC) generally denoted 111, a memory controller (MC) generally 112, and dynamic random-access memory (DRAM), generally 113 connected to the SoC 100. In the example of FIG. 1, the memory subsystem includes four memory channels, although other systems may include more or fewer memory channels. Each memory channel may include its own functional components. For instance, memory channel 1 will have a dedicated SLC 111a, a channel memory controller 112a and DRAM 113a. Memory channel 2 has a dedicated SLC 111b, a channel memory controller 112b and DRAM 113b. Memory channel 3 has a dedicated SLC 111c, a channel memory controller 112c and DRAM 113c. Finally, memory channel 4 has a dedicated SLC 111d, a channel memory controller 112d and DRAM 113d.

Each memory component requires some amount of power to operate. An external power management integrated circuit (PMIC) provides power and each memory channel selectively receives power through power gating controlled through the SoC. Power manager 141 provides hardware and software services of power management of the SoC via system fabric 140 to support each memory channel supported by memory fabric 110. Devices implemented as SoC 100 can be mobile devices that are typically powered by portable energy sources such as batteries. In this regard, power source 141 may include batteries that provide power used to support the components of the SoC 100 including the components of the memory channels 111, 112, 113. During operations, components of the SoC, including the memory components 111, 112, 113 deplete the energy stored in the system battery and reduce the battery’s state of charge. When the battery is sufficiently depleted, the battery can no longer support operations of the device. The battery must be recharged prior to that point to maintain operation of the device as intended. Although FIG. 1 shows the power source 141 as being part of the SoC 100, the power source may be positioned off of the SoC. Additionally, there may be more than one power source, such as multiple batteries.

Battery life, including length of charge is often a consideration in the design, marketing, and use of portable electronic devices. To extend the effective time of battery operation, either more energy must be provided by the battery itself, or the demands on the battery must be reduced. Increasing battery capacity often results in increased device size and cost, therefore energy saving techniques may be used to obtain or maintain small form factors and reduced costs of high-tech devices.

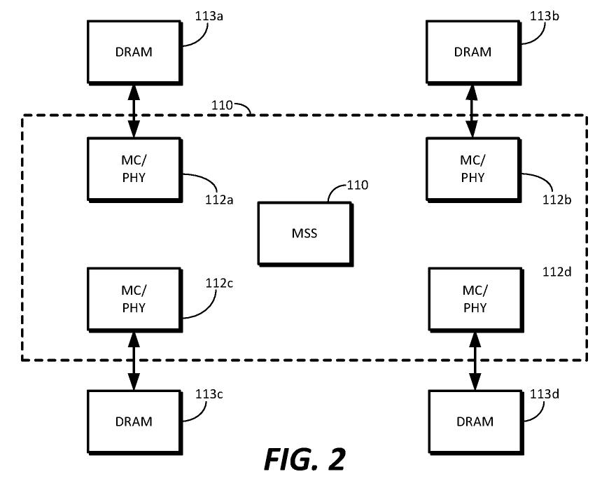

FIG. 2 is a block diagram illustrating a quad-channel memory system, which shows a configuration of a multi-channel compute device. Memory subsystem (MSS) 110 includes a number of memory channels that operate in cooperation to provide faster and more efficient memory operations for the compute device associated with the memory channels. Each memory channel includes a DRAM 113. Memory channel 1 includes DRAM 113a, memory channel 2 includes DRAM 113b, memory channel 3 includes DRAM 113c, and memory channel 4 includes DRAM 113d. Each memory channel further includes a memory controller that establishes a physical layer (PHY) 112 connecting the DRAM 113 to the device. Memory channel 1 includes MC/PHY 112a, memory channel 2 includes MC/PHY 112b, memory channel 3 includes MC/PHY 112c, and memory channel 4 includes MC/PHY 112d. In operation each DRAM 113 as well as each memory controller 112 requires power to operate. Each memory channel draws the power necessary to supply its associated MC/PHY 112 and DRAM 113 with power to operate the memory channel. In a device having four memory channels, each of the four memory channels will draw power from the device and its power source to maintain operations of the active memory channels.

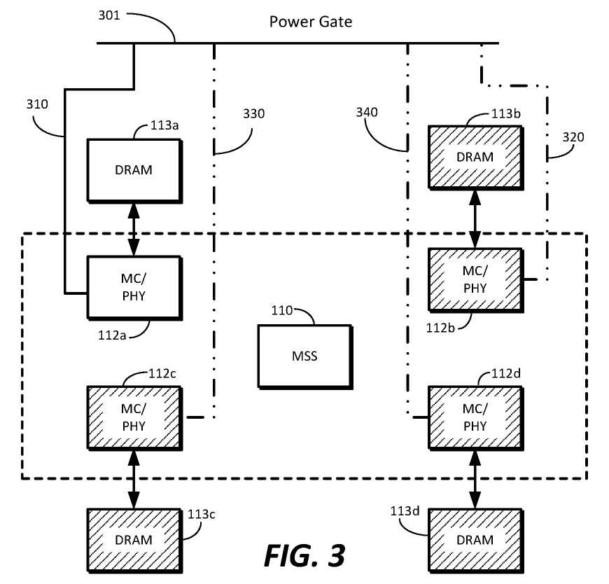

FIG. 3 is a block diagram of the quad-channel memory system of FIG. 2 which is configured to selectively disable memory channels according to aspects of the technology described in this disclosure. As referenced in the description of FIG. 2 above, each active memory channel draws power from the device’s power source to power the DRAM 113 and the MC/PHY 112 of every active memory channel. While additional memory channels contribute to performance of the device, the increase in performance comes at the expense of battery life.

According to aspects of the technology described herein, a number of memory channels in a multi-channel memory device can be selectively disabled or turned off to conserve power. In practice, a user inputs a preference to the device to enter a power save mode, such as through an interface. In power save mode, one or more of the currently active memory channels will be turned off. This action comes at the expense of performance but will result in reduced power requirements of the device. As a consequence, battery life of the device will be preserved and extended. In a scenario where a user has a battery-operated mobile device and finds themselves without access to a charger or external power source, it may be deemed beneficial to reduce performance of the device in order to conserve power to make the batter last longer.

In operation, the user may enter an instruction for a device to enter a power save mode via a user interface. Entering the power save mode may require the device to reboot in order to reconfigure the memory subsystem 110 of the system. Upon reboot, the device can read the user’s preference from the device bootloader (DBL). Commands may then be issued to provide power only to the memory channels specified by the user preference. Further, the boot process may instruct the memory to conform to the number of remaining active memory channels. Memory address hash tables may be configured to distribute memory addresses between the one or more memory channels that remain active.

Referring to FIG. 2, the user’s request is to operate the device with a single memory channel. As the system reboots, the power gate 301 directs power to the MC/PHY 112a and DRAM 113a of memory channel 1 310. In contrast, the power gate 301 breaks power to memory channel 2 320, memory channel 3 330, and memory channel 4 340. As a result, MC/PHY 112b and DRAM 113b of memory channel 2 are powered down. MC/PHY 112c and DRAM 113c of memory channel 3 are powered down. MC/PHY 112d and DRAM 113d of memory channel 4 are powered down. The overall result is a reduction in power of 75% from a state where all four memory channels are active due to the power demands of the multi-channel memory system. The device will operate relying on one memory channel using DRAM 113a and MC/PHY 112a to operate the device albeit at a lower performance level than when all memory channels are active. This is an improvement to conventional devices that do not offer the option to choose between performance and battery life. The device can be used for extended periods and allow for continued operation of the device.

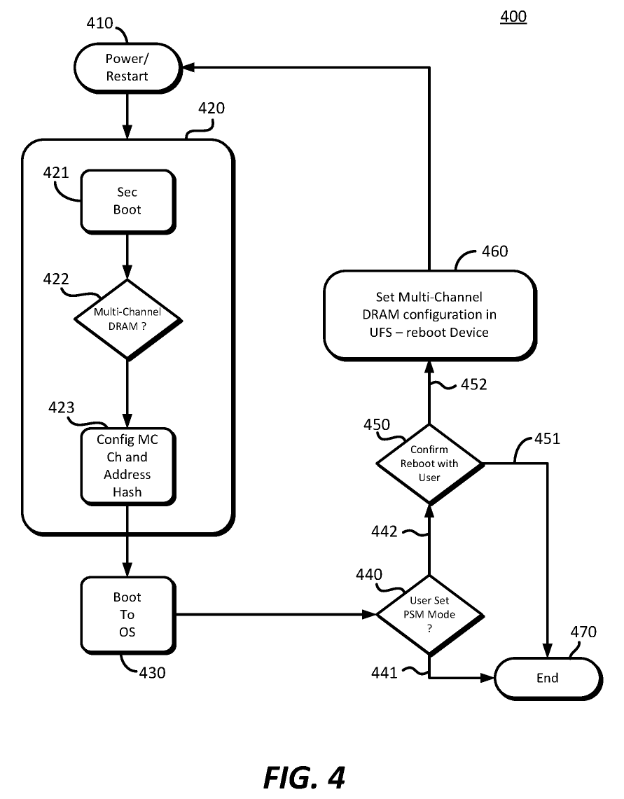

FIG. 4 is a flow diagram for activating a power save mode in a multi-channel compute device 400 according to aspects of the disclosed technology. Beginning with a typical startup, the power up signal is sent to the device. For example, in a mobile phone example, the user may press a power button to start the device 410. The device may then go through a booting process 420 to initialize the operating state of the device. From a secured memory location, a secured bootloader instruction 421 is executed to obtain the baseline settings for starting the device. The secured bootloader instruction 421 includes a user preference with respect to the device’s multi-channel memory state. If the user preference indicates that the device will operate using more than one memory channel 422, the memory controllers, memory channels and memory address hash is computed 423. Once the device is prepared to utilize the memory configuration, the device can be booted to the operating system (OS) 430. At this point, the OS is running and the user and/or device sensors can provide inputs to the OS that are processed to produce outputs that direct the running and display of the device.

During runtime of the device, a user may determine that it is advantageous to sacrifice some performance of the device in exchange for extending battery life of the device. For example, the device may be mobile phone and the user may not have access to a phone charger or may not be near an external power source to charge the mobile phone. In this case, the user may indicate a desire to enter power save mode (PSM) 440. By way of example, a user may enter the settings menu of the device. The settings menu may include an option to enter power saving mode. The menu selection may include additional options such as a number of memory channels to turn off to conserve power. If the user decides not to use PSM 441, the process ends 470 and the device returns to runtime. In order to initialize the device to use a new memory configuration, the device must be restarted and rebooted. To verify the user’s intent 442 and to notify the user that the device will restart to enter PSM, the user is presented with a notification to confirm the reboot 450. At this point, the user may cancel the request 451 and the process ends 470 with the device returning to runtime.

If the user confirms the selection to enter PSM 452, the user’s preferences are captured from the settings menu options and the multi-channel DRAM configuration is saved to the bootloader 460. The user selection may be saved to a secured portion of the bootloader, including a universal flash storage (UFS) partition in the device bootloader. A command is executed to reboot the device and the device restarts 410 and the boot process 420 updates with the newly entered user preferences.

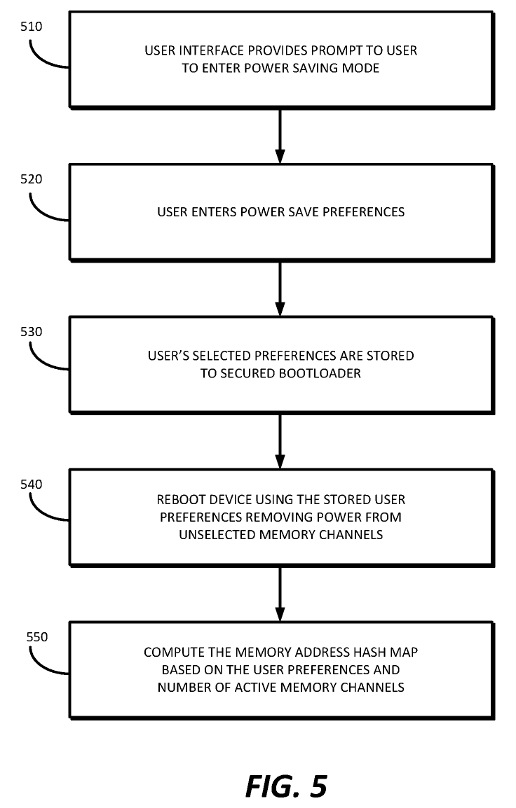

FIG. 5 is a process flow diagram describing the entering of a power save mode in a multi-channel compute device according to the described technology. A user interface in the device (e.g., the setting menu in a mobile phone) prompts the user to allow the user to enter the PSM 510. Using the user interface, the user inputs the user’s preferences with respect to the power save mode 520. The user’s entered preferences are captured and stored to a secured area of the device bootloader 530. A command is issued to restart the device using the updated user preferences for power save mode including configurations for eliminating power to the unselected memory channels 540. The device restarts and computes an updated memory address hash map to comply with the remaining number of active memory channels as specified by the user preferences 550.

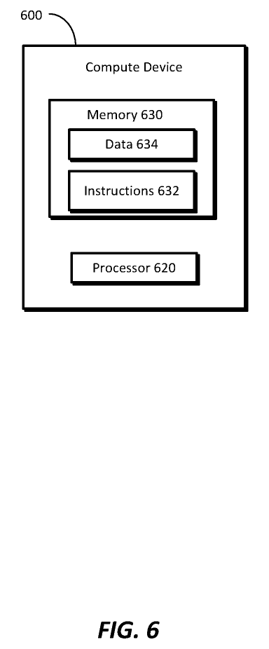

FIG. 6 is a block diagram of a compute device which may be used to implement aspects of the disclosed technology. Compute device 600 may be personal computer or a mobile device, intended for use by a person. Compute device 600 having all the internal components normally found in a personal computer such as a central processing unit, CD-ROM, hard drive, and a display device, for example, a monitor having a screen, a projector, a touch-screen, a small LCD screen, a television, or another device such as an electrical device that can be operable to display information processed by a processor 620, speakers, a modem and or network interface device, user input such as a mouse, keyboard, touchscreen, or microphone, and all of the components used for connecting these elements to one another. Moreover, computers in accordance with the systems and methods described herein may include devices capable of processing instructions and transmitting data to and from humans and other computers including general purpose computers, PDAs, tablets, mobile phones, smartwatches, network computers lacking local storage capability, set top boxes for televisions, and other networked devices.

The compute device 600 may contain a processor 620, memory 630, and other components typically present in general-purpose computers. The memory 630 can store information accessible by the processor 620 including instructions 632 that can be executed by the processor 620. Memory can also include data 634 that can be retrieved, manipulated or stored by the processor 620. The memory 630 may a type of non-transitory computer readable medium capable of storing information accessible by the processor 620, such as a hard-drive, solid state drive, tape drive, optical storage, memory card, ROM, RAM DVD, CD-ROM, write-capable and read-only memories. The processor 620 can be a well-known processor or other lesser-known type of processor. Alternatively, the processor 620 can be a dedicated controller such as an Application Specific Integrated Circuit (ASIC)

The instructions 632 can be a set of instructions executed directly, such as machine code, or indirectly, such as scripts by the processor 620. In this regard, the terms “instructions,’ “steps” and “programs” can be used interchangeably herein. The instructions 632 can be stored in object code format for direct processing by the processor 620, or other types of computer language including scripts or collections of independent source code modules that are interpreted on demand or compiled in advance.

The data 634 can be retrieved, stored or modified by the processor 620 in accordance with the instructions 632. For instance, although the system and method are not limited to a particular data structure, the data 634 can be stored in computer registers, in a data store as a structure having a plurality of different fields and records, or documents, or buffers. The data 634 can include information sufficient to identify relevant information, such as numbers, descriptive text, proprietary codes, pointers, references to data stored in other memories, including other network locations, or information that is used by a function to calculate relevant data. Although FIG. 6 functionally illustrates a single processor 620 with a single memory 630, there could actually be multiple processors and memories that may or may not be in direct proximity to each other. For example, a compute device may include multiple memories arranged in a multi-channel memory system defining multiple memory channels, each possessing its own memory. In some cases, each memory channel may include an associated microprocessor serving as a memory controller. The compute device may include multiple processing units, including data processing units, central processing units, graphics processing units, and the like.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

The described technology provides features that conserve energy and prolong battery life in portable devices by selectively providing power to a selected number of memory channels in a multi-channel memory device. The features include:

Feature 1 receives in a processor a request to enter a power save mode in a device comprising a multi-channel DRAM module and responsive to the request turning off at least one first memory channel of the multi-channel DRAM module and configuring the multi-channel DRAM module in the power saving mode to use a remaining at least one second memory channel.

Feature 2 includes feature 1, wherein the multi-channel DRAM module comprises a system on chip.

Feature 3 includes any of features 1-2 wherein the request to enter the power save mode is receive from a user.

Feature 4 includes any of features 1-3 further comprising receiving a user preference, the user preference comprising a selection of at least one memory channel to turn off in the power saving mode, wherein turning off the at least one first memory channel is based on the user preference.

Feature 5 includes any of features 1-4 further comprising wherein the user preference is stored in a configuration setting in the multi-channel DRAM module, and the user preference is received from the configuration setting.

Feature 6 includes any of features 1-5 further comprising storing the user preference in a secured universal flash storage (UFS) partition on the multi-channel DRAM module.

Feature 7 includes any of features 1-6, wherein configuring the multi-channel DRAM module comprises rebooting the device comprising the multi-channel DRAM module based on the user preference stored in the secured UFS.

Feature 8 includes any of features 1-7 further comprising outputting for display, an indication that the device comprising the multi-channel DRAM module will be rebooted in response to the request to enter the power saving mode.

Feature 9 includes any of features 1-8 further including outputting for display, with the indication, an option to cancel the request to enter the power saving mode and/or to reboot the device comprising the multi-channel DRAM module in the power saving mode.

Feature 10 includes any of features 1-9 further including locking out enablement of the power saving mode during runtime of the device comprising the multi-channel DRAM module.

Feature 11 includes any of features 1-10 further including for each of the at least one second memory channels, calculating a memory address hash map.

Feature 12 includes any of features 1-11 further comprising storing, within a secured bootloader, the user preference, wherein the secured bootloader prohibits enabling of the power saving mode when the device comprising the multi-channel DRAM module is in runtime.

Feature 13 includes a compute device including a compute processor, a memory in communication with the processor, the memory including a plurality of memory channels, and a power save module configured to reduce power consumption of the compute device by selectively turning off a subset of the plurality of memory channels.

Feature 14 includes feature 13 wherein the power save module includes a user interface, the user interface configured to prompt a user to select a power save mode of the compute device.

Feature 15 includes any of features 13-14 including a secured bootloader partition for storing a preference of the user received via the user interface.

Feature 16 includes any of features 13-15 including a universal flash storage (UFS) partition containing the secure bootloader partition storing the user preference.

Feature 17 includes any of features 13-16, wherein the compute device comprises a system on a chip (SoC).

Feature 18 includes any of features 13-17 including a memory module containing instructions that when executed by the compute processor, cause the compute processor to initialize a memory address hash map for a number of active memory channels of the plurality of memory channels.

Feature 19 includes any of features 13-18 including the memory module further containing instructions to secure activation of a power saving mode or against alteration of a power save state of the device during runtime.

Feature 20 includes any of features 13-19 including a selectable option for entering the power saving mode, the selectable option indicating a number of memory channels of the plurality of memory channels to turn off to conserve power.

1. A method comprising:
receiving, by one or more processors, a request to enter a power saving mode in a device comprising a multi-channel dynamic random-access memory (DRAM) module;
responsive to the request, turning off at least one first memory channel of the multi-channel DRAM module; and
configuring the multi-channel DRAM module, in the power saving mode, to use a remaining at least one second memory channel.

2. The method of claim 1, wherein the multi-channel DRAM module comprises a system on chip (SoC).

3. The method of claim 1, wherein the request to enter the power saving mode is received from a user.

4. The method of claim 1, further comprising:
receiving a user preference, the user preference comprising a selection of at least one memory channel to turn off in the power saving mode, wherein turning off the at least one first memory channel is based on the user preference.

5. The method of claim 4, further comprising:
wherein the user preference is stored in a configuration setting in the multi-channel DRAM module, and the user preference is received from the configuration setting.

6. The method of claim 5, further comprising:
storing the user preference in a secured universal flash storage (UFS) partition on the multi-channel DRAM module.

7. The method of claim 6, wherein configuring the multi-channel DRAM module comprises rebooting the device comprising the multi-channel DRAM module based on the user preference stored in the secured UFS.

8. The method of claim 7, further comprising:
outputting for display, an indication that the device comprising the multi-channel DRAM module will be rebooted in response to the request to enter the power saving mode.

9. The method of claim 8, further comprising:
outputting for display, with the indication, an option to cancel the request to enter the power saving mode and/or to reboot the device comprising the multi-channel DRAM module in the power saving mode.

10. The method of claim 1, further comprising:
locking out enablement of the power saving mode during runtime of the device comprising the multi-channel DRAM module.

11. The method of claim 1, further comprising:
for each of the at least one second memory channels, calculating a memory address hash map.

12. The method of claim 4 further comprising:
storing, within a secured bootloader, the user preference, wherein the secured bootloader prohibits enabling of the power saving mode when the device comprising the multi-channel DRAM module is in runtime.

13. A compute device comprising:
a compute processor;
a memory in communication with the processor, the memory comprising a plurality of memory channels; and
a power save module configured to reduce power consumption of the compute device by selectively turning off a subset of the plurality of memory channels.

14. The compute device of claim 13, the power save module comprising:
a user interface, the user interface configured to prompt a user to select a power save mode of the compute device.

15. The compute device of claim 14, further comprising:
a secured bootloader partition for storing a preference of the user received via the user interface.

16. The compute device of claim 15, further comprising:
a universal flash storage (UFS) partition containing the secure bootloader partition storing the user preference.

17. The compute device of claim 16, wherein the compute device comprises a system on a chip (SoC).

18. The compute device of claim 13, further comprising:
a memory module containing instructions that when executed by the compute processor, cause the compute processor to initialize a memory address hash map for a number of active memory channels of the plurality of memory channels.

19. The compute device of claim 18, further comprising:
the memory module further containing instructions to secure activation of a power saving mode or against alteration of a power save state of the device during runtime.

20. The compute device of claim 14, wherein the user interface further comprises:
a selectable option for entering the power saving mode, the selectable option indicating a number of memory channels of the plurality of memory channels to turn off to conserve power.
